(19) United States
(12) Patent Application Publication
(10) Pub. No.: US 2016/0261308 A1
(43) Pub. Date: Sep. 8, 2016

(54) ARCHITECTURE FOR CANCELLING SELF INTERFERENCE AND ENABLING FULL DUPLEX COMMUNICATIONS

(71) Applicant: NEC Laboratories America, Inc., Princeton, NJ (US)

(72) Inventors: Mohammad Khojastepour, Lawrenceville, NJ (US); Sampath Rangarajan, Bridgewater, NJ (US)

(21) Appl. No.: 15/056,477

(22) Filed: Feb. 29, 2016

Related U.S. Application Data
(60) Provisional application No. 62/127,503, filed on Mar. 3, 2015.

(51) Int. Cl. H04B 3/20; H04B 7/10; H04B 1/56; H04L 5/14

(52) U.S. Cl. CPC H04B 3/20; H04L 5/1461; H04B 7/10; H04B 1/56

(57) ABSTRACT

Methods and systems are provided for cancelling self-interference in a wireless communication system is provided. One of the methods includes placing a first set of antennas in an omni-directional antenna pattern, wherein the first set of antennas includes a plurality of directional antenna elements in a node. The method further includes forming, using the first set of antennas, an isolated null region wherein at least one antenna in a second set of antennas is used for reception or transmission, wherein the second set of antennas includes at least one omni-directional antenna in the same node.

### RELATED APPLICATION INFORMATION

This application claims priority to provisional application Ser. No. 62/127,503 filed on Mar. 3, 2015, incorporated herein by reference.

### BACKGROUND

1. Technical Field

The present invention relates to interference caused by wireless communication and, in particular, to cancelling self-interference in wireless communication systems.

2. Description of the Related Art

When a signal is sent over a wireless communication system, that signal has the capability of reflecting off of any number of surfaces. These reflected signals include at least a portion of the original signal that was transmitted. If a component of a wireless communication system includes both a transmitter and a receiver, some of the signal sent by the transmitter may be received by the receiver due to the original signal being reflected. This results in a type of interference known as self-interference, which is often undesirable.

### SUMMARY

A method, according to an embodiment of the present principles, of cancelling self-interference in a wireless communication system is provided. The method includes placing a first set of antennas in an omni-directional antenna pattern, wherein the first set of antennas includes a plurality of directional antenna elements in a node. The method further includes forming, using the first set of antennas, an isolated null region wherein at least one antenna in a second set of antennas is used for reception or transmission, wherein the second set of antennas includes at least one omni-directional antenna in the same node as the first set of antenna.

A method, according to an embodiment of the present principles, of cancelling self-interference in a wireless communication system is provided. The method includes placing, in a wireless communications system, a first antenna and a second antenna, wherein the first antenna and the second antenna are each configured to perform simultaneous transmission and reception. The method further includes configuring a transmission from the first antenna and a reception of the second antenna to a same first frequency band. The method additionally includes configuring a transmission from the second antenna and a reception of the first antenna to a same second frequency band.

A system, according to an embodiment of the present principles, is provided for cancelling self-interference in a wireless communication system. The system includes a first set of antennas, wherein the first set of antennas includes a plurality of directional antenna elements in a node. The system also includes a second set of antennas, wherein the second set of antennas includes at least one omni-directional antenna in the node. In the system, the plurality of directional antennas are configured to work in conjunction in order to transmit or receive and are placed such that they form an omni-directional antenna pattern while generating an isolated null region in a region wherein the at least one omni-directional antenna is used for reception or transmission. Additionally, in the system, the plurality of directional antennas are placed in the isolated null region.

These and other features and advantages will become apparent from the following detailed description of illustrative embodiments thereof, which is to be read in connection with the accompanying drawings.

### BRIEF DESCRIPTION OF THE DRAWINGS

FIG. 1 shows a system 100 forming an exemplary well-isolated singular region 140 for an antenna 110, in accordance with an embodiment of the present principles;

FIG. 2 shows a diagram of a conventional Half Duplex (HD) communication system 200 with a single antenna (230, 235) serving as both a transmit and a receive antenna, in accordance with an embodiment of the present principles;

FIG. 3 shows a diagram of a Full Duplex (FD) communication system 300 with two separate antennas (330, 332 and 335, 337), in accordance with an embodiment of the present principles;

FIG. 4 shows a diagram of an example of an HD Multiple Input Multiple Output (HD-MIMO) system 400, in accordance with an embodiment of the present principles;

FIG. 5 shows a diagram of an example of an FD Switched Frequency Architecture (FD-SFA) system 500, in accordance with an embodiment of the present principles;

FIG. 6 shows a flowchart of a method 600 of cancelling self-interference in wireless communication systems, in accordance with an embodiment of the present principles;

FIG. 7 shows a diagram of an example of a system 700 forming an exemplary well-isolated singular region 740 by method 600 of FIG. 6, in accordance with an embodiment of the present principles; and

FIG. 8 shows a flowchart of a method 800 of cancelling self-interference in wireless communication systems, in accordance with an embodiment of the present principles.

### DETAILED DESCRIPTION OF PREFERRED EMBODIMENTS

In accordance with the present principles, systems and methods are provided for cancelling self-interference in wireless communication systems.

In one approach to cancel self-interference, antennas of a device are placed such that the received power of a signal at a receive antenna is negligible (or reduced) from the transmission of the signal from a transmit antenna. This reduces the effect of any self-interference caused by the transmit antenna. This type of self-interference cancellation can be achieved by the placement of the antennas. Controlling the placement of the antennas includes controlling the distance between the antennas as well as controlling the direction of the antennas in three-dimensional region, which comprises the polarization and the beam pattern of the antenna.

Antennas are not all of the same type. There are multiples types of antennas, such as directional antennas and omni-directional antennas. Directional antennas are antennas with a narrow beam pattern and, in particular, antennas that can focus most of the transmit power within a limited angular cone around a main transmit direction that can be designed or used, e.g., to have negligible transmission power beyond the angular cone. Good antenna candidates to achieve this directional antenna property include, e.g., dish antennas, horn antennas, etc.

In another example of the cancellation of self-interference, antenna attenuations are added, which reduce the strength of a signal being sent from, or to, an antenna. An attenuation beyond a threshold angle (from the main transmission axis of the antenna) is called the antenna attenuation. When two antennas are placed at a particular distance in which the coupling between the antennas is not occurring, the received power of a signal at a receive antenna is only a function of the transmitted signal from a transmit antenna and the channel from the transmit antenna to the receive antenna. For example, at a distance beyond one for which near-field assumption holds, the far-field transmission and reception follows the propagation of an electromagnetic (EM) wave and not of any coupling effect.

In an embodiment, two antennas placed such that both antennas have parallel main-transmission-axis. These antennas would have an additive attenuation. This means that, if the transmit power is attenuated beyond an angular threshold (e.g., 30 dB) and the antennas are placed outside this angular threshold, then the receiver also receives the signal with attenuated power (e.g., 20 dB). For example, in the scenario in which the angular threshold is 30 dB and the attenuated power is 20 dB, the total angular attenuation due to the antenna patterns for the signal transmitted from the transmit antenna to the receive antenna will be roughly 50 dB.

The total attenuation between two antennas is a function of the distance between the two antennas. The free space path loss is calculated as [20*log 10(4*π*d/λ)], in terms of dB, where d is a distance and λ is a wavelength. The air absorption is usually extra. In a multi-path environment, there is an extra factor, as well, due to an out-of-phase combination of signals from multiple paths.

There are at least two types of scenarios in which self-interference cancellation is of interest; directional communication and omni-directional communication.

In the first scenario, directional communication (usually a point-to-point case), a direction (or a limited number of multiple known directions) of transmission and reception is provided. This scenario occurs, for example, in backhaul design, where a high speed link between two points is desired. In this scenario, self-interference cancellation can be better achieved and highly directional antennas can productively contribute to the self-interference cancellation. The use of Radio Frequency (RF) absorbers between the antennas is also possible as the angle of arrival from one or more adjacent antennas in a single device is quite different from the angle of arrival of the signal of interest.

In the second scenario, omni-directional communication, a single device is connected to multiple receivers or to a single receiver without known a priori directions. In omni-directional communication scenarios, it is necessary to design omni-directional antennas for transmission and reception. Additionally, the interference would be very dominant. Handling self-interference cancellation in such a scenario may require additional levels of cancellation, such as antenna cancellation, in which multiple transmit antennas generate a null at given points where the receive antenna (or antennas) will be placed, or vice versa, i.e., multiple receive antennas cancel out the transmissions from a transmitting point by destructively combining the signals in their RF circuits.

In an embodiment in which self-interference cancellation occurs during omni-directional communication, a design advantageously incorporates the fact that a far-field signal in closer proximities has different characteristics from a far-field signal that is arriving from a direction of interest. Some of the main differences include that the far-field signals in close proximity exhibit different fading characteristics and that, if there are no near obstacles, these signals may not have a strong fading effect. Hence, the distance between the antennas are controlled in such a way that mutual coupling (or the near-field effect) does not happen while the distances are still small enough to make sure that almost free space attenuation is possible.

In this embodiment, there may still be a need for cancelling a multi-path to some degree. The same assumption would have different fading characteristics for the transmission point that is further away, which would follow the usual fading (e.g., Rayleigh or Rician) characteristics. Additionally, in this embodiment, it is possible to use antenna polarization for further isolation between self-transmit and receive antennas and also possible to reach a higher self-interference cancellation.

This embodiment may also employ RF absorbers that are carefully inserted in the main paths between the self-transmit and receive antennas. Such an RF absorber would considerably reduce the self-interference signal while having negligible (or at least a controlled) effect on the signal of interest coming from further distances.

In another embodiment of the present principles, a design for self-interference cancellation during omni-directional communication generates a far-field omni-directional antenna with a confined isolated region. In this embodiment, the design approach uses multiple omni-directional antennas and transmits the same (up to a power and phase difference) signal from the multiple antennas that, in effect, generates singular points in space where the signals from the multiple antennas destructively combine. This additionally places the receive antennas in such singular or null points.

In another embodiment, the design uses multiple element antennas, wherein each element is a directional antenna and the combination of the elements generates an omni-directional antenna in the far field of far proximity. Nonetheless, in near proximity, the antennas may be placed such that at least a null region (a well-isolated region from the multiple transmitter antenna elements) is obtained.

It should be understood that embodiments described herein may be entirely hardware or may include both hardware and software elements, which includes but is not limited to firmware, resident software, microcode, etc. In a preferred embodiment, the present invention is implemented in hardware.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

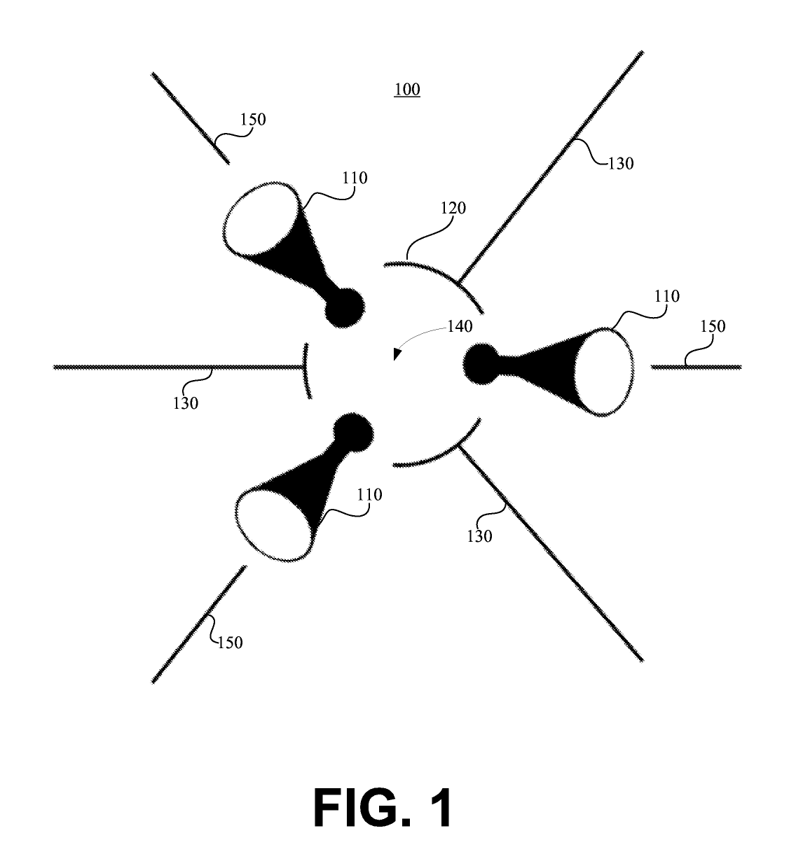

Referring now to the drawings in which like numerals represent the same or similar elements and initially to FIG. 1, a diagram of system 100 which can be used to form an exemplary well-isolated singular region 140 for an antenna is shown.

In an embodiment of the present principles, multiple well-directional patch antennas 110 are placed in near proximity around a particular region 140. These antennas 110 send a signal 150 in a forward direction. This forward direction faces a away from the region 140 formed by the placement of the antennas 110. The placement of these antennas 110 aids in the isolation of region 140. This isolation aids in the prevention of signals 130 entering the region.

For example, if there are three well directional patch antennas 110 that have 50 dB isolation between the backward versus forward direction and have a beam pattern 150 with about a 120 degree angle in the forward direction, these antennas may be placed in, e.g., a perimeter of a circle at 0, 120, and 240 degree angles such that the main transmission angles are also aligned with the 0, 120, and 240 degree angles. Such placement of the three-antenna 110 element generates an almost-omni-directional pattern outside the circle while a roughly 50 dB isolation is achieved inside the circle. This region 140 of isolation within the circle is called the “ISOLAR” region or the “well ISOlated singuLAR region.”

The isolar region of an antenna (which can be composed of, e.g., multiple elements) is defined as the region, in close proximity to the antenna, that is highly isolated from the transmitted signal from the antenna (or group of antennas if it is composed of multiple elements) in cases where the antenna is a transmit antenna. Similarly, in the case that the antenna is a receive antenna, an isolar region is a region that is in close proximity to the antenna wherein the transmitted signals from that region are highly attenuated in comparison to other regions, when this signal is received by this antenna.

It is noted that, even in the isolar region, the signals transmitted from the multiple elements may combine. In an embodiment of the present principles, this type of signal leakage is overcome, wherein a singular processing approach is used in which a signal processor configured to generate destructive interference between a leakage of the plurality of the directional antennas located in the isolated null region in order to further decrease leakage in the isolated null region. Hence, it is possible to design the phase shift and power adjustment between the signals transmitted from all of the elements such that, in some singular point or isolar region, even more isolation can be achieved.

In an embodiment, the isolar region or the singular points of a transmit antenna, multi-element transmit antenna, or multiple transmit antenna system, may be used for placement of receive antennas. Similarly, in another embodiment, the isolar region or singular points of a receive antenna, the multi-element receive antenna, or the multiple receive antenna system may be used for placement of transmit antennas.

Due to reciprocity, it is possible to switch the role of the transmit and receive antennas. For example, in an embodiment, instead of a transmit antenna being composed of multiple elements and a receive antenna that is omni-directional, it is possible for the receive antennas to be composed of multiple elements and the transmit antenna to be omni-directional.

Self-interference in directional communication scenarios can take advantage of directional antennas where transmit and receive antennas can be placed in a direction adjacently facing the direction of transmission. In an embodiment, one level of isolation is achieved through the antenna attenuation that is the attenuation of the antenna with respect to its main direction of communication. Antenna attenuations for both transmit and receive antennas are usually additive. Another level of isolation comes from the distance between the antennas and is due to signal attenuation in three-dimensional (isotropic or non-isotropic) space. This can also be calculated as the free space path loss, given by [20*log 10(4*π*d/λ)], in terms of dB, where d is a distance and λ is a wavelength. Yet another level of isolation can be achieved by placing RF absorbers in the path between the transmit and the receive antennas of the same device to further cancel self-interference.

There are various types of communications systems with which self-interference cancellation systems and techniques can be used. These communications systems include, for example, Half Duplex (HD) communication systems and Full Duplex (FD) communication systems.

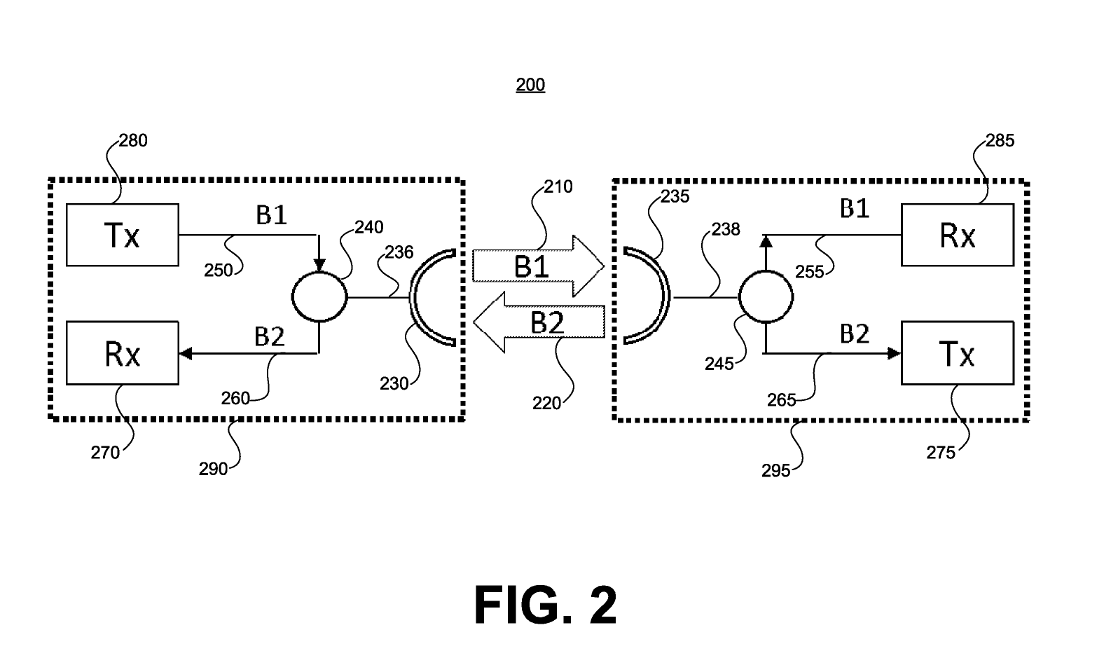

FIG. 2 shows a diagram of a conventional HD system 200 with a single antenna 230, 235 that serves as both a transmit and a receive antenna, in accordance with an embodiment of the present principles. The system requires one transmitter RF chain 270, 275 and one receiver RF chain 280, 285 per antenna 230, 235.

One type of HD system is a Time Division Duplex (TDD) system. In a TDD system, an antenna feeder 236, 238 is connected to a TDD switch that connects the antenna to either a transmitter RF chain 270, 275 or a receiver RF chain 280, 285.

Another type of HD system is a Frequency Division Duplex (FDD) system. In an FDD system, the antenna feeder 236, 238 is connected to a circulator 240, 245 that is connected to the transmitter RF chain 270, 275 and the receiver RF chain 280, 285 via transmit signal paths 260, 265 and receive signal paths 250, 255, respectively. The circulator 240, 245 isolates the transmitter RF chain 270, 275 and the receiver RF chain 280, 285 and connects them simultaneously to the antennas 230, 235 so that the device can transmit and receive at the same time in different frequencies.

As shown in FIG. 2, in an embodiment of the present principles, communication nodes 290, 295 are connected by frequency bands 210, 220, wherein frequency band B1 210 enables transmission from communication node 290 to communication node 295 (e.g., in DownLink (DL)) and frequency band B2 220 enables transmission from communication node 295 to communication node 290 (e.g., in uplink (UL)). Therefore, the total bandwidth used by the system is B1+B2.

The total transmit power per device is usually restricted per regulations by the FCC. Some restrictions may be applied to the power of the transmit signals per an antenna or an antenna aperture as well as a maximum antenna gain (in terms of dBi) per antennas or per antenna arrays that consist of multiple elements.

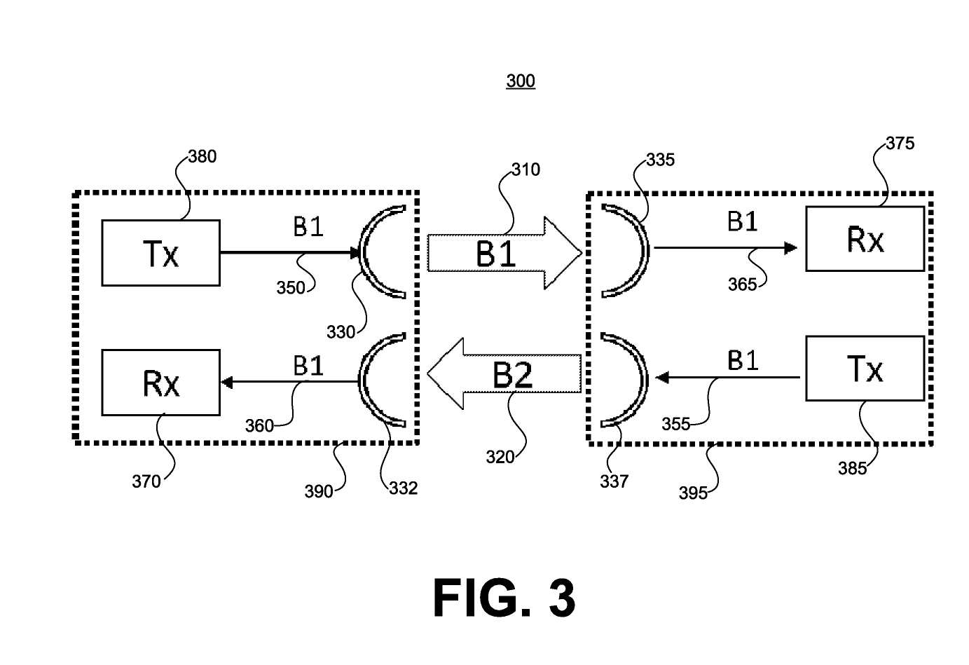

FIG. 3 shows a diagram of an example of an FD system 300 with two separate antennas (330, 332 and 335, 337, respectively), in accordance with an embodiment of the present principles.

There are two separate antennas 330, 332 and 335, 337, in each communication node 390, 395 in the FD system 300, as opposed to the HD system 200, which has one antenna 230, 235 for both transmission and reception. In the FD system 300, one of the antennas 330, 337 serves as a transmit antenna and the other antenna 332, 335 serves as a receive antenna. Therefore, one of the antennas 330, 337 is connected to a transmitter RF chain 380, 385 via a transmit signal path 350, 355 and the other antenna 332, 335 is connected to a receiver RF chain 370, 375 via a receive signal path 360, 365.

A frequency band B1 310 (or multiple frequency bands B1+B2) is used for both transmissions from communication node 390 to communication node 395 (e.g., DL) and a frequency band B2 320 is used for transmission from communication node 395 to communication node 390 (e.g., UL). The total transmit power per device is usually restricted per regulations by the FCC. Some restriction may be applied to the power of the transmit signals per antenna or antenna aperture as well as a maximum antenna gain (in terms of dBi) per antennas or per antenna arrays that consist of multiple elements.

One of the differences between FD 300 and HD 200 systems is how much bandwidth must be exploited to achieve the same capacity. Assuming a single stream transmission in either direction for both HD 200 and FD 300 systems using the same transmit power per device, an FD system, using half the frequency bands as a HD system, exploits half of the bandwidth of an HD system to achieve the same capacity using the same transmit power.

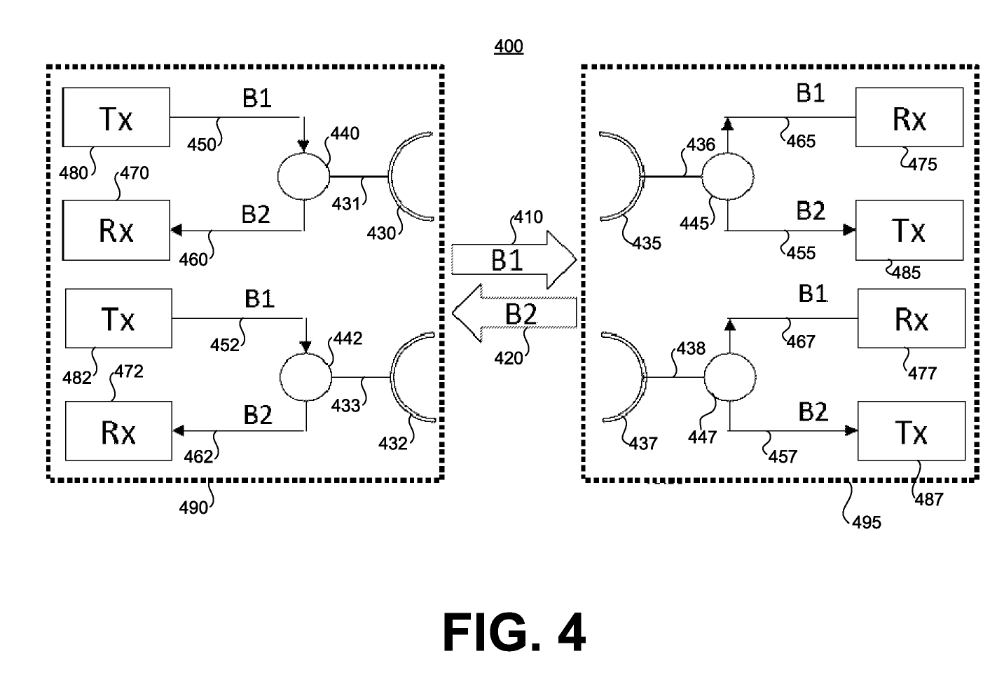

An example of an HD system is an HD Multiple Input Multiple Output (HD-MIMO) system 400. FIG. 4 shows an example of an HD-MIMO system 400, in accordance with an embodiment of the present principles.

While HD systems 200 have one antenna functioning as both a transmission antenna and a receiving antenna, an HD system may have more than one antenna in any one device. Since an FD system 300 uses two separate antennas for transmission and reception, an FD system may be compared with an HD system with two antennas at each end.

In one scenario, an HD-MIMO system 400 is created in which an HD system sends one stream from two antennas (430, 432 and 435, 437, respectively), wherein the single stream is precoded using both antennas. Such a system 400 includes two antennas (430 and 432 for communication node 490, and 435 and 437 for communication node 495), two transmitter RF chains (480 and 482 for communication node 490, and 485 and 487 for communication node 495), two receiver RF chains (470 and 472 for communication node 490, and 475 and 477 for communication node 495), a transmit power P (P/2 from each antenna), a bandwidth of B1+B2, and a single stream transmission. It is noted that an HD-MIMO system 400 may have more than two antennas.

In the HD-MIMO system 400, each of the antennas (430, 432, 435, 437) is connected to a circulator (440, 442, 445, 447) via an antenna feeder (431, 433, 436, 438). The circulator (440, 442, 445, 447) connects to the transmitter RF chain (480, 482, 485, 487) via a transmit signal path (450, 452, 455, 457) and connects to the receiver RF chain (470, 472, 475, 477) via a receiver signal path (460, 462, 465, 467). With careful design of the precoder, the HD-MIMO system 400, using a single stream transmission, can achieve 3 dB of power gain due to the coherent combining in either of a Line-Of-Sight (LOS) environment or a Non-Line-Of-Sight (NLOS) environment with low delay feedback. Communication nodes 490, 495 are connected by frequency bands 410, 420, wherein frequency band B1 410 enables transmission from communication node 490 to communication node 495 (e.g., in DL) and frequency band B2 420 enables transmission from communication node 495 to communication node 490 (e.g., in UL).

The FD system can then use both frequency bands, B1 and B2, and, hence, achieve one stream transmission in each band while lacking the power gain of coherent combining.

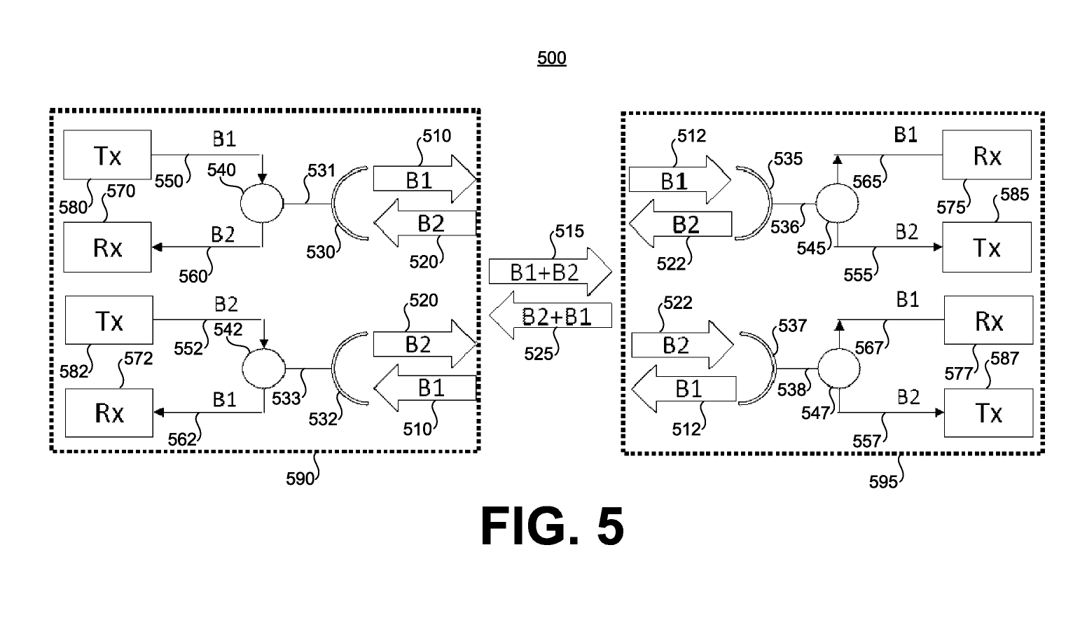

An example of an FD system is a FD Switched Frequency Architecture (FD-SFA) system 500. FIG. 5 shows an example of an FD-SFA system 500, in accordance with an embodiment of the present principles.

In an FD system with isolated transmit and receive antennas, the function of the transmit and the receive antennas may be reversed in two different frequency bands, creating an FD-SFA system 500. In FDD HD systems, usually the transmit and receive frequency bands are not in adjacent frequency bands.

A FD system, working, for example, on the same frequency band of a FDD HD system, can exploit an FD-SFA system 500 in which a transmitter RF chain (580, 587) in one frequency band, e.g., B1 (510, 512), and a receiver RF chain (570, 577) in another frequency band, e.g., B2 (520, 522), are connected, e.g., by using a circulator (540, 547), to one antenna (530, 537). The antenna (530, 537) is connected to the circulator (540, 547) via an antenna feeder (531, 538), the transmitter RF chain (580, 587) via a transmit signal path (550, 557), and the receiver RF chain (570, 577) via a receive signal path (560, 567). The other antenna (532, 535) is then connected to the transmitter RF chain (582, 585) and the receiver RF chain (572, 575) in reverse order of the frequency bands (510 and 520 in communication node 590, and 512 and 522 in communication node 595). The other antenna (532, 535) is connected to the circulator (542, 545) via an antenna feeder (533, 536), the transmitter RF chain (582, 585) via a transmit signal path (552, 555), and the receiver RF chain (572, 577) via a receive signal path (562, 565).

In the FD-SFA system 500, it is possible to simultaneously transmit and receive a single stream in both frequency bands, B1 and B2 ((B1+B2) 515, and (B2+B1) 525). Extension of the FD-SFA system 500 to multiple antenna systems with multiple streams in each frequency band is possible. For example, using an FD node with M transmit antennas and N receive antennas in, for example, frequency band B1 (510, 512), it is possible to build a FD-SFA node with M transmit antennas and N receive antennas in frequency band B1 and N transmit antennas and M receive antennas in frequency band B2. In an embodiment, the first antenna and the second antenna are directional antennas. In another embodiment, a radiation pattern formed by the first antenna and a radiation pattern formed by the second antenna face the same direction.

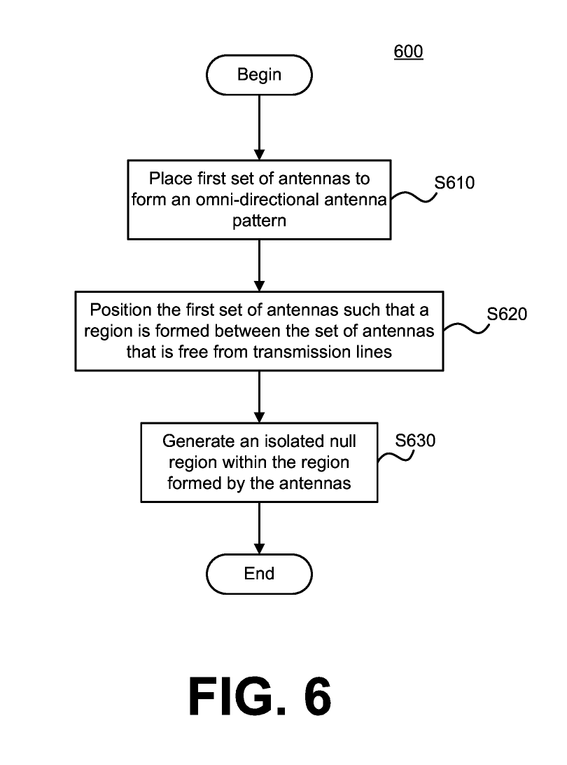

Referring now to FIG. 6, a flowchart of a method 600 of cancelling self-interference in wireless communication systems is shown, in accordance with an embodiment of the present principles.

At S610, a first set of antennas are placed in a wireless communications system, forming an omni-directional pattern. In an embodiment, the first set of antennas includes a plurality of directional antenna elements a node. At S620, the first set of antennas are positioned such that their position forms a region between the first set of antennas, wherein the region that is formed is free from antenna transmission lines while maintaining the omni-directional pattern formed by the first set of antennas.

At S630, an isolated null region between the antennas is formed. The placement of the first set of antennas aids in the isolation of the isolated null region, and this isolation aids in the prevention of signals entering the region. In addition to being isolated, the isolated null region is also a region where at least one antenna in a second set of antennas is used for reception or transmission, wherein the second set of antennas includes at least one omni-directional antenna in the same node as the first set of antennas.

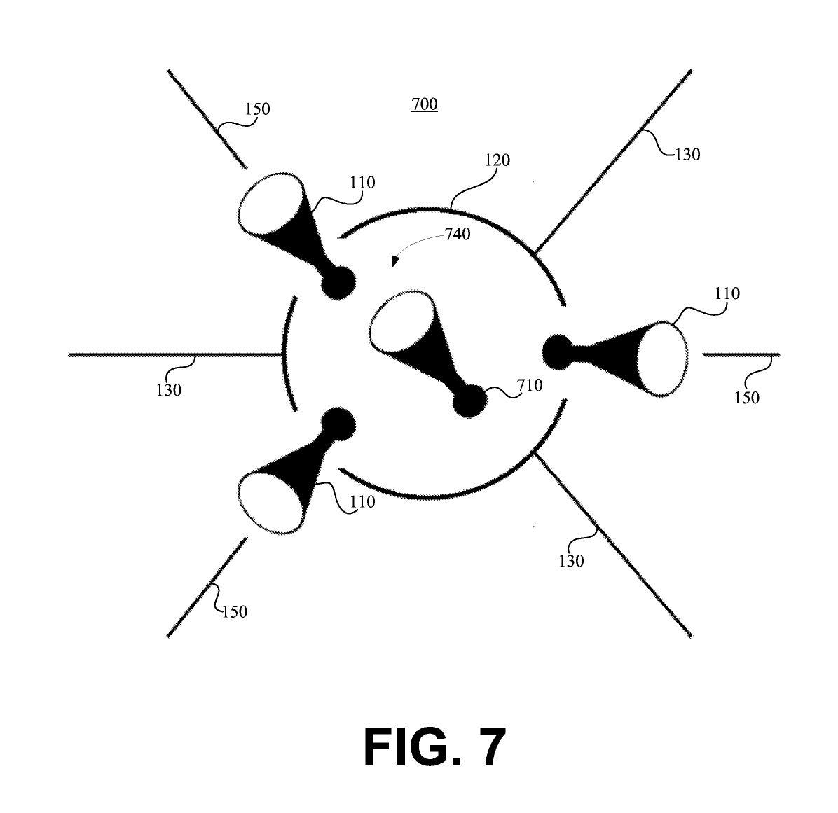

FIG. 7 shows a diagram of an example of a system 700 which forms the exemplary well-isolated singular region 740 formed by the method 600 of FIG. 6.

In an embodiment of the present principles, multiple well-directional patch antennas 110 are placed in near proximity around a particular region 740 and form an omni-directional pattern. These antennas 110 send a signal 150 in a forward direction. This forward direction faces a direction away from the region 740 formed by the placement of the antennas 110. The placement of these antennas 110 aids in the isolation of region 740. This isolation aids in the prevention of signals 130 entering the region. For example, if there were three antennas 110, each antenna 110 may a transmission lobe of roughly 120 degrees. These three antennas 110 together would cover the whole 360 degree angle around region 740 such that the radiation patterns from all of the antennas 110 would encompass all of the omni-directional pattern around the isolar region 740. From an observer that is far away from these antennas 110, the combination of these three antennas 110 would appear as a pattern of a single dipole antenna 720 that is omni-directional and within region 740. Within the isolar region 740 is a second set of antennas which includes at least one omni-directional antenna 710.

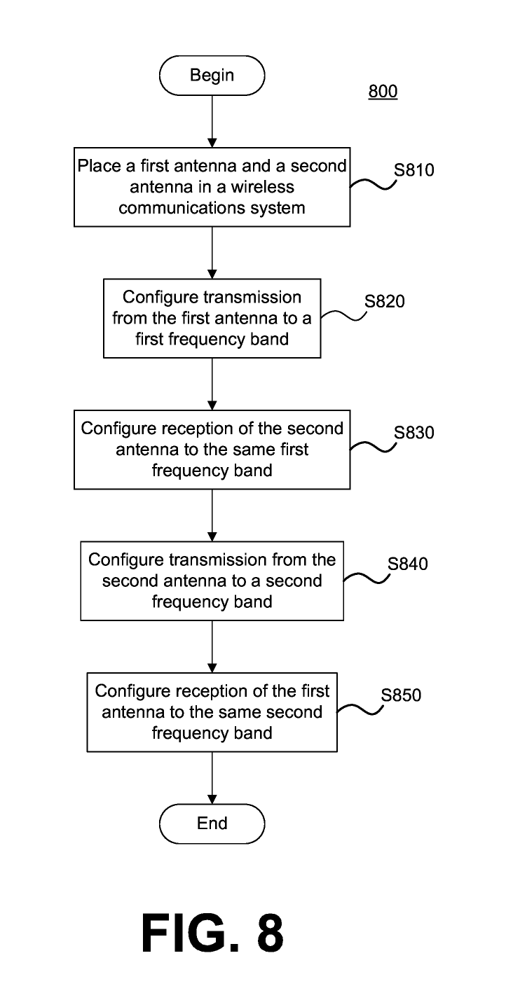

Referring now to FIG. 8, a flowchart of a method 700 of cancelling self-interference in wireless communication systems is shown, in accordance with an embodiment of the present principles.

At S810, a first antenna and a second antenna are placed in a wireless communications system. In an embodiment, the first antenna and the second antenna are each configured to perform simultaneous transmission and reception.

At S820, the transmission from the first antenna is configured to a first frequency band. At S830, the reception of the second antenna is configured to the same first frequency band. Therefore, after S820 and S830, the transmission from the first antenna and the reception of the second antenna are configured to the same frequency band.

At S840, the transmission from the second antenna is configured to a second frequency band. At S850, the reception of the first antenna is configured to the same second frequency band. Therefore, after S840 and S850, the transmission from the second antenna and the reception of the first antenna are configured to the same frequency band.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

It should be understood that embodiments described herein may be entirely hardware, or may include both hardware and software elements which includes, but is not limited to, firmware, resident software, microcode, etc.

1. A method of cancelling self-interference in a wireless communication system, the method comprising:
placing a first set of antennas in an omni-directional antenna pattern; and
forming, using the first set of antennas, an isolated null region wherein at least one antenna in a second set of antennas is used for reception or transmission,
wherein the first set of antennas includes a plurality of directional antenna elements in a node, and
wherein the second set of antennas includes at least one omni-directional antenna in the node.

2. The method of claim 1, wherein the plurality of directional antennas are placed on a convex contour such that the omni-directional pattern is covered for transmission or reception by the plurality of directional antennas and an area inside the contour is the isolated null region,
wherein the omni-directional pattern includes an area outside the contour.

3. The method of claim 1, further comprising generating, using a signal processor, destructive interference between a leakage of the plurality of the directional antennas located in the isolated null region in order to decrease leakage in the isolated null region.

4. The method of claim 1, further comprising isolating the first set of antennas and the second set of antennas from each other to enable a simultaneous transmission and reception in a same frequency band.

5. The method of claim 4, wherein, at any given time, the first set of antennas is used for transmission and the second set of antennas are used for reception.

6. The method of claim 4, wherein, at any given time, the first set of antennas is used for reception and the second set of antennas are used for transmission.

7. The method of claim 4, further comprising controlling a distance between a plurality of antennas within the first set of antennas so as to prevent mutual coupling.

8. A method of cancelling self-interference in a wireless communication system, the method comprising:
placing, in a wireless communications system, a first antenna and a second antenna, wherein the first antenna and the second antenna are each configured to perform simultaneous transmission and reception;
configuring a transmission from the first antenna and a reception from the second antenna in a same first frequency band; and
configuring a transmission from the second antenna and a reception from the first antenna in a same second frequency band.

9. The method of claim 8, wherein the first antenna and the second antenna are directional antennas.

10. The method of claim 9, wherein a radiation pattern formed by the first antenna and a radiation pattern formed by the second antenna face a same direction.

11. The method of claim 10, wherein the placing of the first antenna and the second antenna further includes placing the first antenna and the second antenna in a direction perpendicular to a plane formed between the antennas.

12. The method of claim 8, wherein the first antenna and the second antenna use a same amount of power.

13. The method of claim 8, wherein the transmission and reception of the first antenna are performed in reverse order of frequency bands of the transmission and reception of the second antenna.

14. A system for cancelling self-interference in a wireless communication system, the system comprising:
a first set of antennas, wherein the first set of antennas includes a plurality of directional antenna elements in a node; and
a second set of antennas, wherein the second set of antennas includes at least one omni-directional antenna in the node,
wherein the first set of antennas are configured to cooperatively transmit or receive and are placed such that they form an omni-directional antenna pattern while generating an isolated null region wherein the at least one omni-directional antenna is used for reception or transmission.

15. The system of claim 14, wherein the first set of antennas are placed on a convex contour such that the omni-directional pattern is covered for transmission or reception by the first set of antennas and an area inside the contour is the isolated null region,
wherein the omni-directional pattern includes an area outside the contour.

16. The system of claim 14, further comprising a signal processor configured to generate destructive interference between a leakage of the first set of antennas located in the isolated null region in order to decrease leakage in the isolated null region.

17. The system of claim 14, wherein the first set of antennas and the second set of antennas are isolated from each other to enable a simultaneous transmission and reception in a same frequency band.

18. The system of claim 17, wherein, at any given time, the first set of antennas is used for transmission and the second set of antennas are used for reception.

19. The system of claim 17, wherein, at any given time, the first set of antennas is used for reception and the second set of antennas are used for transmission.

20. The system of claim 14, wherein a distance between a plurality of antennas within the first set of antennas is controlled so as to prevent mutual coupling.
